(19) United States
(12) Patent Application Publication
(10) Pub. No.: US 2007/0059217 A1
(43) Pub. Date: Mar. 15, 2007

(54) PROCESS FOR THE PRODUCTION OF BIOPOLYMER FIELDS WITH REAL-TIME CONTROL

(76) Inventors: Heinz Eipel, Bensheim (DE); Markus Beier, Heidelberg (DE); Stefan Matysiak, Tettnang (DE)

Correspondence Address: NOVAK DRUCE DELUCA & QUIGG, LLP, 1300 EYE STREET NW, SUITE 1000 WEST TOWER, WASHINGTON, DC, 20005, US

(21) Appl. No.: 11/556,650

(22) Filed: Nov. 3, 2006

Related U.S. Application Data
(63) Continuation of application No. 10/257,326, filed on Oct. 10, 2002, now abandoned.

(30) Foreign Application Priority Data
Apr. 10, 2000 (DE) 10017790.5

(51) Int. Cl. B01L 3/02

(52) U.S. Cl. 422/100

(57) ABSTRACT

The invention relates to a process and a device for the determination of the transfer of a sample substance in the production of biopolymer fields or biopolymer arrays onto the surface (4) of a specimen slide (3). The surface (4) of a specimen slide (3) comprises a conductive material (14) whose electrical connection to the feed device (1) via the sample liquid (12) serves as acknowledgement signal (8).

The present invention relates to a process for the production of biopolymer fields with real-time control for improving the quality of biopolymer arrangements produced for analytical purposes.

Biopolymer fields or biopolymer arrays are nowadays produced by principally two processes. In a procedure which has been practiced hitherto for the transfer of extremely small amounts of biopolymer solutions to a support material, extremely small amounts of biopolymer solutions are applied as small measurements dots to surfaces of specimen slides by means of the ink-jet printing method. However, this process is afflicted with uncertainty in the sample application due to viscosity differences occurring in the sample solutions to be applied and occasional formation of gas bubbles in the ink-jet printer.

Another procedure for the application of biopolymer fields to specimen-slide surfaces comprises applying extremely small amounts of liquid of samples to be analyzed to surfaces of specimen slides by means of a nib. The term ‘nib’ in this connection is taken to mean nibs as can be employed, for example, on fountain pens. For application of biopolymer arrays arranged in regular form, it is necessary that, for liquid transfer, the nib or needle wetted with the liquid sample to be applied makes good liquid contact each time with the surface to be charged, since otherwise the desired amount of sample cannot be transferred in adequate amount or not at all.

Errors which occasionally occur during liquid sample transfer are frequently not noticed until all the sample spots of a biopolymer array or biopolymer field have been arranged fully on the surface of the respective specimen slide. The gaps remaining in the biopolymer array arrangement make evaluation of the biopolymer array by automatic means more difficult. It is not economically acceptable to await complete finishing of an error-containing biopolymer.

To date, checking of the completeness of biopolymer fields produced on the surface of specimen slides has been carried out using video cameras, but these, owing to their physical size, require valuable space in the miniaturized environment of the transfer region. Furthermore, the signals from the video cameras can only be automated with relatively high effort.

In view of the disadvantages afflicting the solution from the prior art, it is an object of the present invention to achieve an improvement in the quality of biopolymer fields to be produced even during their production.

We have found that this object is achieved by a process for observing sample transfer in the production of biopolymer fields on the surface of specimen slides, wherein the surface of the specimen slide comprises a conductive material whose electrical connection to the feed device via the sample material serves as acknowledgement signal.

The advantages of the solution proposed in accordance with the invention are principally that, in the process proposed, liquid contact can be ascertained, after application of a voltage, through electrical current flowing between the feed device and the electrically conductive layer on the slide. Since the liquid within the feed device is electrically conductive due to buffer ions present therein, the biopolymer sample to be analyzed, which has been applied to the conductive coating of the slide, represents a liquid bridge which closes the current circuit between the slide surface provided with conductive material and the feed device. This enables highly reliable detection of application of a biopolymer sample sufficient for analysis to the specimen slide, so that, through a correspondingly generated and amplified acknowledgement signal if liquid contact has not taken place, the command to repeat the filling or transfer operation is given to the computer controlling the feed device, until acknowledgement of the liquid contact takes place or, after a plurality of unsuccessful attempts, a corresponding entry in the error record of a control computer can be effected.

In a further embodiment of the proposed process according to the invention, the monitoring of the liquid contact of sample and surface of the specimen slide takes place in real time.

The acknowledgement signal is particularly advantageously generated from a detected current flow between the feed device and the conductive surface of the specimen slide. The sample liquid is advantageously used here as liquid bridge between the feed device and the specimen slide.

In order to obtain a meaningful acknowledgement signal which can be processed further, the signal emanating from a detected current flow is amplified by a high-resistance amplifier arrangement. A pre-resistance of, for example, 10 megaohms can be installed upstream of the high-resistance amplifier.

The correspondingly amplified acknowledgement signal can be utilized for automatic initiation of a repetition of the transfer operation by corresponding addressing of the feed device if it has been detected that no liquid bridge generating a current flow between the feed device and the surface of the specimen slide has been applied between these.

In accordance with the present invention, a device is furthermore proposed for the detection of the transfer of a sample quantity of a biopolymer from a feed device onto the surface of a specimen slide, where the feed device contains a conductor which effects current flow and generates a signal via the sample liquid with a surface of the specimen slide comprising a conductive material, having a connection.

In comparison with the solution known from the prior art for monitoring the quality of a biopolymer field using video cameras and further processing their signals, the solution according to the invention represents a significantly simpler and more reliable real-time monitoring possibility. The electrical conductor which cooperates with the electrical connection of the specimen slide can advantageously be embedded in the mount of the capillary tube serving as feed device for the sample liquid and can simply be connected to a voltage source together with the connection of the specimen slide.

According to a further refinement of the idea on which the invention is based, the surface of the specimen slide can consist of electrically conductive plastic, while the specimen slide itself can be made of a less expensive material. The surface of the specimen slide can consist of metallic material, for example in an applied thin metal plate.

Finally, it is also conceivable to make the sample slides out of glass or plastic and to render them electrically conductive by application of a conductive material. The conductive coating of the specimen slide made of less expensive material may be an electrically conductive polymer. The electrically conductive coating may furthermore consist of metal or a semiconductor material. An example of a semiconductor material which can be employed is indium-tin oxide, where, for cost reasons, the entire surface of the coating of the specimen slide need not be coated with a conductive material, but instead, in certain applications, a coating of part-areas of the specimen-slide surface with conductive material may be sufficient.

The invention is explained in greater detail below with reference to the drawing.

The single FIGURE shows a diagrammatic representation of an arrangement serving for real-time monitoring of a biopolymer array.

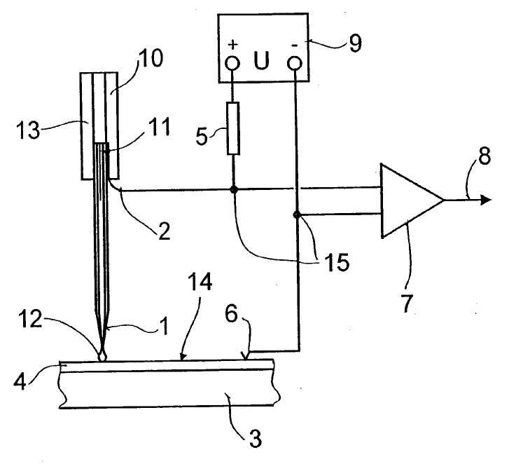

According to the arrangement shown in FIG. 1, the capillary tip 1 of a capillary tube 11 is positioned against a surface 4 of a specimen slide 3. The surface 4 of the specimen slide 3 comprises a conductive coating 14. The conductive coating 14 may consist of an electrically conductive polymer. It may be made of metal or comprise a semiconductor material. Indium-tin oxide has proven successful as the semiconductor material to be applied to the surface 4 of the specimen slide 3. It is of course also possible to apply other semiconductor materials as conductive material to the surface 4 of the specimen slide 3.

By contrast, the specimen slide 3 consists of an inexpensive material, for example plastic, metal or glass. An electrical conductor 2 is provided in the mount 13 of the capillary tube 11 and is electrically connected to the sample liquid present in the interior of the capillary tube 11, which liquid leaves the capillary tube 11 at its lower end in the region of the capillary tip 1 in the direction of the surface 14 of the specimen slide 3. The conductor wire 2 is connected to an input of an amplifier 7 and is connected to a voltage source 9 via a pre-resistance 5 of, for example, 10megaohms. The surface 4 with conductive material 14 is connected via a supply line to a voltage source 9 through a connection 6 positioned against the surface in a resilient manner. The resilient connection 6 is likewise connected to an input of the amplifier, which, in particular, has a high-resistance design, in which an acknowledgement signal 8 is generated. At the voltage tap point 15, the conductor wire 2 is connected to the pre-resistance 5 of the voltage source 9, and the connection 6 positioned against the surface 4 in a resilient manner is connected to the input of the high-resistance amplifier 7.

For transfer of the extremely small quantities of liquid in the picoliter and nanoliter range, use is made, for example, of a glass capillary 1, which is drawn out to a fine tip with a diameter of, for example, 100 microns and surrounds a thin conductor wire 2, by means of which the electrical connection to the biopolymer sample to be transferred takes place. The liquid is electrically conductive due to buffer ions present therein.

The specimen slides 3 employed for the biopolymer fields or arrays to be created can be the specimen slides usual in microscopy, with a conductive coating 14, for example with the semiconductor material indium-tin oxide, which are provided with electrical contacts via the connection 6 positioned against these in a resilient manner. In order to achieve a strong covalent chemical bond and electrostatic binding of the biopolymers to be transferred with the surface 4 of the specimen slide 3, which is coated with a conductive material 14, a thin polymer layer, for example polylysine or polyethyleneimine, may be applied to the conductive coating 14.

A voltage of, for example, five volts is applied via a pre-resistance 5 of, for example, 10 megaohms between the specimen slides 3 and the surface 4 accommodated therein, including conductive coating and the liquid in the capillary tube 11. If liquid contact has occurred between the capillary tip I and the conductive coating 14 on the surface 4 of the specimen slide 3, the measurement voltage is short-circuited, since the conductor wire 2 and the connection 6, which is in contact with the conductive coating 14, are connected to a voltage source 9. The presence of a liquid bridge 12 between the aperture of the capillary tip 1 and the specimen-slide surface 4 provided with a conductive coating 14 is observed, for example, by means of a high-resistance amplifier 7 and passed on to the controlling computer as an acknowledgement signal 8 therefrom for the liquid contact that has taken place.

Further possible embodiments of electrical circuits for effecting detection of the liquid contact are entirely evident to the person skilled in the art and can be employed as an alternative.

If the expected liquid contact in the form of formation of a liquid bridge has not taken place, a command to repeat the filling and transfer operation is submitted to the computer controlling the feed device 1, until an acknowledgement of the liquid contact in the shape of the formation of a liquid bridge 12 between the capillary tip 1 and the conductive coating 14 of the surface 4 takes place. After a plurality of unsuccessful attempts to form a liquid bridge 12 between the aperture of the capillary tip 1 and the conductive coating 14 of the specimen slide 3, a corresponding entry in the error record of the control computer takes place.

This enables an error due to an incorrectly applied sample to be detected directly during production of the biopolymer field or biopolymer array. The acknowledgement signal 8 generated in accordance with the invention can accordingly also be used, besides automatic initiation of a repetition of the transfer operation, for generation of documentation of an observed error during the biopolymer transfer. In a further refinement of the idea on which the invention is based, the capillary tube is moved toward the surface 14 until an electrically conductive contact is formed. In this embodiment, the acknowledgement signal serves for acknowledgement of the contact movement of the tool transferring the biopolymer, for example a capillary tube.

Besides the formation of the conductive coating 14 on the surface 4 of the specimen slide 3 of metallic material or semiconductor compounds, such as the indium-tin oxide mentioned, these can also be made of material containing carbon or carbon compounds.

### List of Reference Symbols

1 Capillary tip feed device
2 Conductor wire
3 Specimen slide
4 Surface
5 Pre-resistance
6 Resilient contact
7 Amplifier
8 Acknowledgement signal
9 Voltage source
10 Capillary head
11 Capillary tube
12 Sample liquid, biopolymer sample
13 Holder
14 Conductive coating
15 Voltage tap point

1-15. (canceled)

16. A process for determination of transfer of a sample substance in production of biopolymer fields on a surface of a specimen slide comprising:
electrically connecting a feed device and a conductor of said specimen slide with a sample liquid producing an acknowledgment signal, wherein the surface of the specimen slide comprises a conductive material; and
determining when a sample substance is applied incorrectly.

17. The process of claim 16, further comprising:
monitoring a liquid contact of the sample liquid and the surface of the specimen slide in real time during application of the sample liquid.

18. The process of claim 16, further comprising:
generating the acknowledgement signal from a current flow between the feed device and the surface of the specimen slide.

19. The process of claim 18, further comprising:
converting a measurement signal emanating from a detected current flow by an amplifier arrangement into the acknowledgement signal, wherein said acknowledgement signal can be processed.

20. The process of claim 16, further comprising:
employing the acknowledgement signal for automatic initiation of a repetition of a transfer operation by a corresponding addressing of the feed device.

21. The process of claim 16, further comprising:
employing the acknowledgement signal for positioning of a sample substance carrier in a Z-direction during the transfer operation.

22. The process of claim 16, further comprising:
employing the acknowledgement signal for automatic documentation of an error during transfer of the sample liquid onto the surface of the specimen slide.

23. A device for the detection of the transfer of a sample liquid of a biopolymer from a feed device onto a surface of a specimen slide comprising:
the feed device having a conductor fluidly connectable via the sample liquid to the surface of the specimen slide, wherein said specimen slide comprises:
a conductive material, said feed device connectable via an electrical connection and a supply line to a voltage source, wherein a voltage tap point is on the conductor, and a current flow across the sample liquid generates the acknowledgement signal.

24. The device of claim 23, wherein the surface of the specimen slide comprises electrically conductive plastic.

25. The device of claim 23, wherein the surface of the specimen slide comprises metallic material.

26. The device of claim 23, wherein the specimen slide comprises at least one of glass and plastic that is rendered conductive by application of a conductive material.

27. The device of claim 26, wherein the conductive coating is an electrically conductive polymer.

28. The device of claim 26, wherein the conductive material is a metal.

29. The device of claim 26, wherein the conductive material is a semiconductor material.

30. The device of claim 29, wherein the semiconductor comprises indium-tin oxide.

31. A process for determining a transfer of a sample:
transferring a sample from a feed device to a substrate, wherein the sample remains electrically connected to the feed device thereby generating an acknowledgement signal;
processing the acknowledgement signal;
monitoring the transfer in real time; and
detecting sample transferred incorrectly.

32. The process of claim 31, further comprising:
initiating at least one second transfer after detection of an incorrect sample transfer.

33. The process of claim 32, further comprising:
repeating sample transfer until the acknowledgment signal is generated.

34. The process of claim 31, further comprising:
recording automatically incorrect sample transfer.

35. The process of claim 31, further comprising:
creating a biopolymer field, wherein the sample binds to the conductive substrate by at least one of a covalent bond and an electrostatic bond.
